(19) United States
(12) Patent Application Publication
(10) Pub. No.: US 2026/0290304 A1
(43) Pub. Date: Sep. 24, 2026

(54) ACOUSTIC REFLECTING NET

(71) Applicant: Toyota Motor Engineering & Manufacturing North America, Inc., Plano, TX (US)

(72) Inventors: Taehwa Lee, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/082,312

(22) Filed: Mar. 18, 2025

(51) Int. Cl. G10K 11/28; G10K 11/162; G10K 11/172

(52) U.S. Cl. CPC G10K 11/28; G10K 11/162; G10K 11/172; G10K 2210/3226; G10K 2210/3227

(57) ABSTRACT

Disclosed herein are examples of acoustic reflecting nets that include resonator strands having a resonance frequency based on a height of a channel disposed along a length of the resonator strands.

### TECHNICAL FIELD

The subject matter described herein relates, in general, to systems and devices for reflecting acoustic waves and, more specifically, to utilizing reflecting nets for reflecting acoustic waves.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Acoustic waves, such as ultrasonic acoustic waves that are typically above 20 kHz and outside the range of human detection, may be used in a variety of different applications. For example, ultrasonic sensors can be utilized to help drivers by detecting obstacles around the vehicle. They emit high-frequency sound waves that bounce off objects and return to the sensor, allowing the system to calculate the distance to the obstacle. This information is then used to guide the driver with visual or auditory alerts. In like manner, automatic guidance systems, such as automatic parking systems, may utilize ultrasonic sensors to automate the parking process, guiding the vehicle into a parking spot without driver intervention.

However, in order for these systems to function properly, the ultrasonic acoustic waves emitted by the ultrasonic sensors should be reflected by an object. In some cases, objects may not be able to properly reflect the ultrasonic acoustic waves because they are made of materials that reduce and/or inhibit this ability. As such, objects made of materials such as these may reduce the functionality of ultrasonic sensors and the systems that rely upon them.

### SUMMARY

This section generally summarizes the disclosure and is not a comprehensive explanation of its full scope or all its features.

In one embodiment, an acoustic reflecting net includes resonator strands having a resonance frequency based on the height of a channel disposed along the length of the resonator strands.

In another embodiment, an acoustic reflecting net for reflecting acoustic waves emitted by an ultrasonic sensor includes resonator strands having a resonance frequency similar to the frequency of the ultrasonic waves emitted by the ultrasonic sensor.

In yet another embodiment, a resonator strand has a resonance frequency based on the height of a channel disposed along the length of the resonator strand. The resonator strand may be used in an acoustic reflecting net.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates an acoustic reflecting net reflecting ultrasonic acoustic waves emitted by an ultrasonic sensor.

FIG. 2A illustrates one example of a resonator strand used with the acoustic reflecting net of FIG. 1.

FIG. 2B illustrates one example of a regular strand that may be used with the acoustic reflecting net of FIG. 1.

FIG. 3A illustrates one example of the acoustic reflecting net having strands that extend in one direction.

FIG. 3B illustrates one example of the acoustic reflecting net having strands that extend in two different directions.

FIG. 4A illustrates one example of the acoustic reflecting net bounded by a frame having strands that extend in one direction.

FIG. 4B illustrates one example of the acoustic reflecting net bounded by a frame having strands that extend in two different directions.

FIG. 5A illustrates the acoustic performance of a net made out of regular strands.

FIG. 5B illustrates the acoustic performance of a net made out of resonator strands.

### DETAILED DESCRIPTION

Described herein is an acoustic reflecting net that can reflect acoustic waves. In one example, the acoustic reflecting net is made up of strands. At least a portion of the strands are resonator strands that have a resonance frequency based on the height of a channel disposed along the length of each of the resonator strands. This arrangement results in an acoustic reflecting net that reflects an acoustic wave that has a frequency similar (within 50%) to the resonance frequency of the resonator strands.

Moreover, when the acoustic wave interacts with the acoustic reflecting net, the acoustic wave transfers energy to the resonator strands, causing them to vibrate. When the frequency of the acoustic wave is similar (within 50%) to the resonance frequency of the resonator strands, the resonator strands vibrate more intensely. The vibration of the resonator strands causes the resonator strands to act as a new source of sound waves that interfere with the incoming acoustic wave. This interference between the incoming acoustic wave and the waves emitted by the resonator strands causes at least part of the incoming acoustic wave to be reflected.

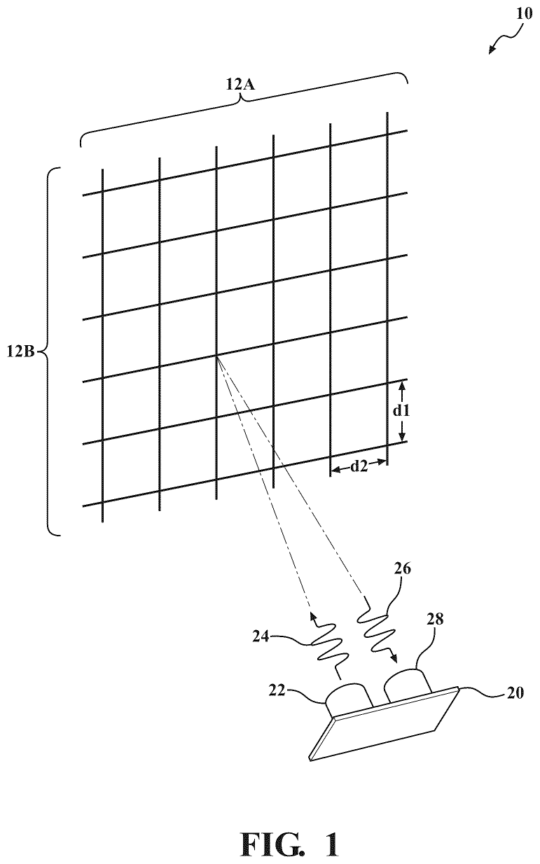

Referring to FIG. 1, illustrated is an acoustic reflecting net 10 that is made up of resonator strands 12A and 12B. In this example, the resonator strands 12A generally extend in the vertical direction, while the resonator strands 12B extend in the horizontal direction. As will be explained later, it should be understood that the acoustic reflecting net 10 can be constructed of resonator strands going in any one of a number of different directions. Generally, the resonator strands 12A and 12B are separated from each other by known distances, d₁ and d₂, respectively. The distances d₁ and d₂ may vary from application to application but generally result in changes in the frequency or range of frequencies reflected by the acoustic reflecting net 10. As such, the distances d₁ and d₂ may be based on the frequency to be reflected by the acoustic reflecting net 10. The resonator strands 12A and 12B may be connected to each other where they overlap or otherwise come into contact using an appropriate adhesive, tape, or other attaching mechanism. However, it should also be understood that the resonator strands 12A and 12B may not be connected to one another.

Further still, it should be understood that the acoustic reflecting net 10 may be constructed of resonator strands going in only one direction. As such, in one example, the acoustic reflecting net 10 may be made up only of the resonator strands 12A (i.e., only made up of vertical direction resonator strands) or the resonator strands 12B (i.e., only made up of horizontal direction resonator strands). Also, as will be explained later, the resonator strands may be intermixed with regular strands that do not resonate at the same frequency as the resonator strands.

Also shown in FIG. 1 is an ultrasonic sensor 20. Here, the ultrasonic sensor 20 generally includes a transmitter 22 and a receiver 28. The ultrasonic sensor 20 may be utilized in a number of different applications, such as robots, vehicles, object detection devices, and the like. As it is generally known, ultrasonic sensors typically have an operating range greater than that detectable by humans. As such, in one example, the ultrasonic sensor 20 may have an operating range of between 20 kHz to 500 kHz. However, it should be understood that the ultrasonic sensor 20 may have an operating range outside of those specifically mentioned.

In this example, the transmitter 22 of the ultrasonic sensor 20 outputs an incoming acoustic wave 24 towards the acoustic reflecting net 10. As described earlier, the resonator strands 12A and 12B begin to resonate when they come in contact with the incoming acoustic wave 24. This resonating effect of the resonator strands 12A and 12B causes at least a portion of the incoming acoustic wave 24 to be reflected back towards the receiver 28 of the ultrasonic sensor 20 as reflected acoustic wave 26. As mentioned before, the resonance frequency of the resonator strands 12A and 12B are similar (within 50%, but possibly less) to the frequency of the incoming acoustic wave 24.

As such, the acoustic reflecting net 10 can be utilized in situations where it is desirable to cause a reflection of the incoming acoustic wave 24. For example, if the ultrasonic sensor 20 is incorporated within a vehicle, robot, or other device, the acoustic reflecting net 10 can be strategically placed so that the vehicle, robot, or other device utilizing the ultrasonic sensor 20 can receive an appropriate reflected acoustic wave. This may be desirable in certain situations where one is trying to cause the vehicle, robot, or other device to follow a certain path by utilizing the acoustic reflecting net 10 to act as a type of wall that the ultrasonic sensor 20 can essentially see, causing the control system of the vehicle, robot, or device to plan an appropriate path.

In other situations, certain objects may be made of materials, such as rubber or other soft materials, which may not sufficiently reflect acoustic waves. In these situations, the acoustic reflecting net 10 can be used to cover these objects so that they can be better detected by the ultrasonic sensor 20.

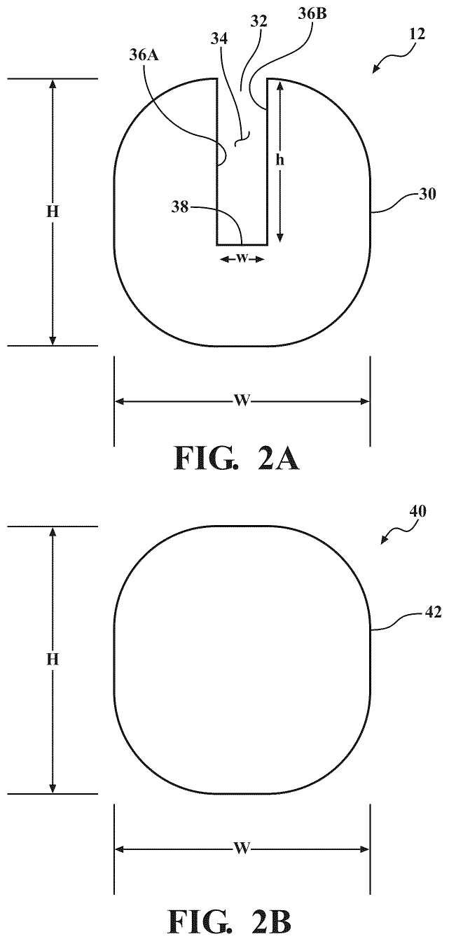

FIG. 2A illustrates a cross-section of a resonator strand 12. The resonator strand 12 may be the same or similar to the resonator strands 12A and/or 12B shown in FIG. 1. The cross-section of the resonator strand 12 has a height (H) and a width (W) that are substantially equal to each other, but can vary from application to application and do not necessarily need to be substantially equal. The resonator strand 12 can be made out of any suitable material, including, but not limited to, plastic, vinyl, rubber, combinations thereof, and the like.

Here, the resonator strand 12 generally includes an outer perimeter 30 that extends around the resonator strand 12. The cross-section of the resonator strand 12 is generally circular but can take any one of a number of different shapes. A channel 34 runs along the length of the resonator strand 12. In some cases, the channel 34 may run along the entire length of the resonator strand 12 or may run only partially along the length of the resonator strand 12.

The channel 34 defines an opening 32 and sidewalls 36A and 36B extending downward towards a base 38. In this example, the sidewalls 36A and 36B have a height (h) that defines the height of the channel 34. The width of the base 38 defines the width (w) of the channel 34. This arrangement causes the resonator strand 12 to act as a quarter-wavelength resonator, wherein the channel 34 acts as a cavity that is one-quarter of the wavelength (λ/4) of the desired resonant frequency. Moreover, the incoming acoustic wave 24 travels to the base 38 of the channel 34 and is reflected. The reflected wave interferes with the incoming wave, creating a standing wave with a maximum amplitude at the opening 32 and the base 38. As such, the resonance frequency of the resonator strand 12 can be defined as

$$f ≅ \frac{c}{4 h}$$

with c being the sound speed in air and h being the height of the sidewalls 36A and 36B (i.e., the depth of the channel 34).

Additionally, the formula

$$f = \frac{c}{( h + d h ) / 4} ,$$

where dh is the end correction, may also be used to determine the resonance frequency of the resonator strand 12. This formal adjusts for the effective channel depth being deeper than the actual depth. This correction may be necessary because the acoustic wave does not start or end exactly at the physical boundaries of the system. Instead, the effective length of the resonant system is different than its physical length.

As mentioned before, the acoustic reflecting net 10 can also include regular strands that do not resonate at the same frequency as the resonator strands 12. A cross-section of a regular strand 40 is illustrated in FIG. 2B. Here, the cross-section of the regular strand 40 has a height (H) and a width (W) that are substantially equal to each other, but can vary from application to application and do not necessarily need to be substantially equal. In some cases, the cross-sectional dimensions of the regular strand 40 may be substantially equal to the cross-sectional dimensions of the resonator strand 12. The regular strand 40 also has an outer perimeter 42 that is substantially circular in shape. The regular strand 40 can be made out of any suitable material, including, but not limited to, plastic, vinyl, rubber, combinations thereof, and the like. Because the regular strand 40 does not include a channel, the regular strand 40 will not resonate in the same manner as the resonator strand 12. As such, they will have different resonance frequencies.

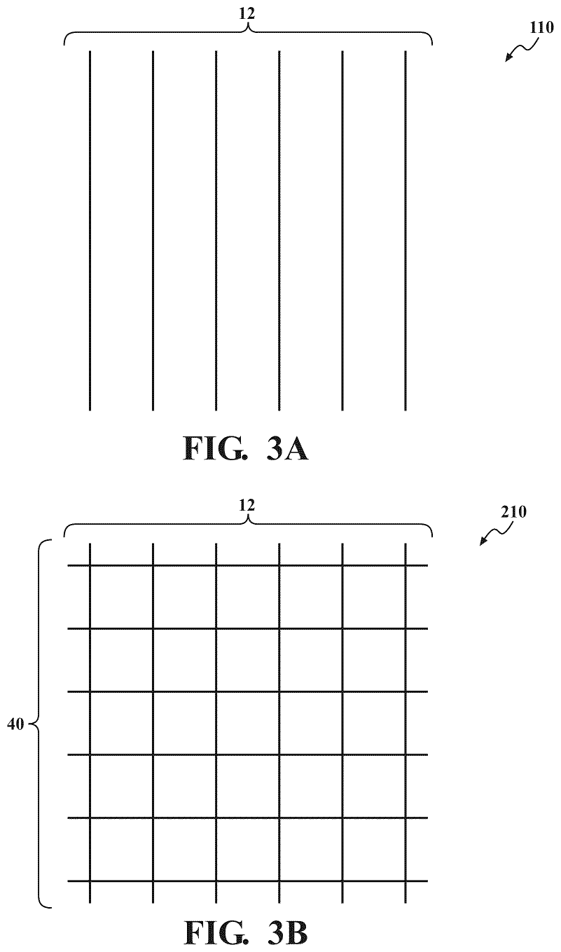

Referring to FIG. 3A, illustrated is another example of an acoustic reflecting net 110. Here, the acoustic reflecting net 110 is shown to include resonator strands 12 that extend in one direction. It should be understood that the direction can vary from application to application. As such, in this example, the direction is shown to be in the vertical direction, but it should be understood that the direction can also be in the horizontal direction. The resonator strands 12 may have similar resonant frequencies (i.e., within 50%) or may have different resonant frequencies.

FIG. 3B illustrates another example of an acoustic reflecting net 210. Here, the acoustic reflecting net 210 is made up of resonator strands 12 that extend in one direction and regular strands 40 that extend in another direction. In this case, the resonator strands 12 extend in the vertical direction and the regular strands 40 extend in the horizontal direction. However, it should be understood the true direction in which the resonator strands 12 and the regular strands 40 extend can be reversed.

The resonator strands 12 in the regular strands 40 may be connected to each other where they overlap or otherwise come into contact using an appropriate adhesive, tape, or other attaching mechanism. However, it should also be understood that the resonator strands 12 and the regular strands 40 may not be connected to one another.

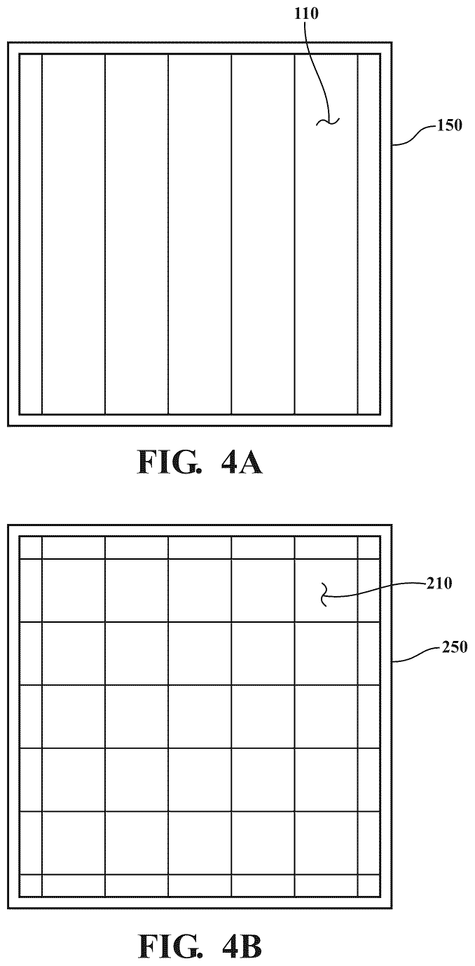

The acoustic reflecting net 10, 110, and/or 210 can be similar to a curtain and can be attached at one end and meant to hang. However, in other examples, the acoustic reflecting net 10, 110, and/or 210 may be mounted within a frame. For example, FIG. 4A illustrates the acoustic reflecting net 110 mounted within a frame 150 while FIG. 4B illustrates the acoustic reflecting net 210 mounted within a frame 250.

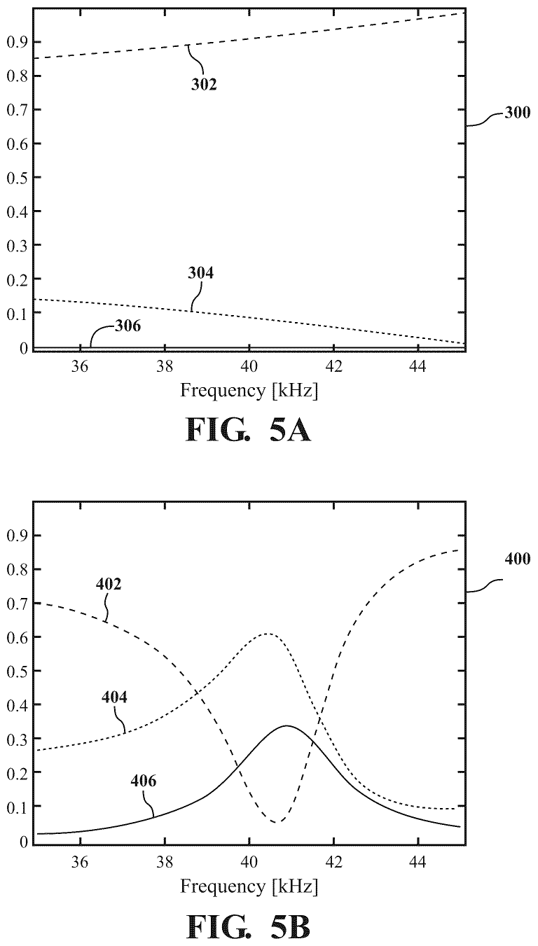

The acoustic reflecting net 10, 110, and/or 210 described herein vastly improve the acoustic reflecting performance of a net made out of only regular strands, such as the regular strands 40. For example, FIG. 5A illustrates a chart 300 showing the transmission 302, reflection 304, and the absorption 306 of a net made out of only regular strands, such as the regular strands 40. In this experiment, the regular strands have a cross-sectional height (H) and width (W) of 2.5 mm each. As these are regular strands, there is no channel. As can be seen in the chart 300, there is fairly high transmission 302 and little reflection 304 and absorption 306 using a net made out of regular strands.

However, FIG. 5B illustrates a chart 400 showing the acoustic performance of the acoustic reflecting net 10 of FIG. 1. Here, the resonator strands 12A and 12B have a cross-sectional height (H) and width (W) of 2.5 mm each. In addition, the resonator strands 12A and 12B have channels with a width (w) of 0.5 mm and a height (h) of 1.5 mm, giving the resonator strands 12A and 12B a resonance frequency of approximately 41.5 kHz, assuming the speed of sound in air is 343 m/s. This was calculated using the formula

$$f = \frac{c}{( h + d h ) / 4} ,$$

where dh is the end correction, which adjusts for the effective channel depth being deeper than the actual depth. This correction may be necessary because the acoustic wave does not start or end exactly at the physical boundaries of the system.

The chart 400 shows the transmission 402, the reflection 404, and the absorption 406 of the acoustic reflecting net 10. Here, the acoustic reflecting net 10 shows approximately 60% reflection of incoming acoustic waves having a frequency of approximately 40 Hz, which is commonly used in ultrasonic sensors. This is a significant performance improvement over using a net made of regular strands, such as shown in FIG. 5A.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

When stating that a frequency is “similar” to another frequency, the term “similar” means within 50% of. As such, this range includes 50% less than and 50% greater than. As an example, a frequency of 10 kHz is similar to a frequency having a range between 15 kHz (50% greater than) and 5 kHz (50% less than).

The headings (such as “Background” and “Summary”) and sub-headings used herein are intended only for the general organization of topics within the present disclosure and are not intended to limit the disclosure of the technology or any aspect thereof. The recitation of multiple embodiments having stated features is not intended to exclude other embodiments having additional features or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one example or various examples means that a particular feature, structure, or characteristic described in connection with an embodiment or particular system is included in at least one embodiment or example. The appearances of the phrase “in one example” (or variations thereof) are not necessarily referring to the same example or embodiment. It should be also understood that the various method steps discussed herein do not have to be carried out in the same order as depicted, and not each method step is required in each example or embodiment.

The foregoing description of the embodiments has been provided for purposes of illustration and description. It is not intended to be exhaustive or to limit the disclosure. Individual elements or features of a particular embodiment are generally not limited to that particular embodiment but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. An acoustic reflecting net comprising resonator strands having a resonance frequency based on a height of a channel disposed along a length of the resonator strands.

2. The acoustic reflecting net of claim 1, wherein at least a portion of the resonator strands are arranged parallel to one another.

3. The acoustic reflecting net of claim 1, wherein at least a portion of the resonator strands are arranged perpendicular to one another.

4. The acoustic reflecting net of claim 1, further comprising regular strands, wherein the resonator strands are arranged perpendicular to the regular strands.

5. The acoustic reflecting net of claim 4, wherein the regular strands do not have a channel.

6. The acoustic reflecting net of claim 1, wherein the resonance frequency of the resonator strands is similar to a frequency of an acoustic wave reflected by the acoustic reflecting net.

7. The acoustic reflecting net of claim 1, further comprising a frame, wherein the resonator strands extend across a portion of the frame.

8. The acoustic reflecting net of claim 1, wherein a first portion of the resonator strands have a first resonance frequency and a second portion of the resonator strands have a second resonance frequency.

9. The acoustic reflecting net of claim 1, wherein the resonator strands are made of at least one of plastic, vinyl, and rubber.

10. An acoustic reflecting net for reflecting acoustic waves emitted by an ultrasonic sensor comprising resonator strands having a resonance frequency similar to a frequency of the acoustic waves emitted by the ultrasonic sensor.

11. The acoustic reflecting net of claim 10, wherein the resonator strands have a channel disposed along a length of the resonator strands, wherein a dimension of the channel is based on the frequency of the acoustic waves emitted by the ultrasonic sensor.

12. The acoustic reflecting net of claim 10, wherein at least a portion of the resonator strands are arranged parallel to one another.

13. The acoustic reflecting net of claim 10, wherein at least a portion of the resonator strands are arranged perpendicular to one another.

14. The acoustic reflecting net of claim 10, further comprising regular strands, wherein the resonator strands are arranged perpendicular to the regular strands.

15. The acoustic reflecting net of claim 14, wherein the regular strands do not have a resonance frequency that is similar to a frequency of the acoustic waves emitted by the ultrasonic sensor.

16. The acoustic reflecting net of claim 10, further comprising a frame, wherein the resonator strands extend across a portion of the frame.

17. The acoustic reflecting net of claim 10, wherein the resonator strands are made of at least one of plastic, vinyl, and rubber.

18. A resonator strand having a resonance frequency based on a height of a channel disposed along a length of the resonator strand.

19. The resonator strand of claim 18, wherein the resonance frequency of the resonator strand is similar to a frequency of ultrasonic waves emitted by an ultrasonic sensor toward the resonator strand.

20. The resonator strand of claim 18, wherein the resonator strand is made of at least one of plastic, vinyl, and rubber.
